(19) United States
(12) Patent Application Publication
(10) Pub. No.: US 2005/0259047 A1
(43) Pub. Date: Nov. 24, 2005

(54) Driving a plasma display panel

(75) Inventors: Bart Andre Salters, Eindhoven (NL); Antonius Hendricus Maria Holtslag, Eindhoven (NL); Fransiscus Jacobus Vossen, Eindhoven (NL); Sander Derksen, Eindhoven (NL); Siebe Tjerk De Zwart, Eindhoven (NL); Pieter Johannes Engelaar, Eindhoven (NL); Petrus Johannes Gerardus Van Lieshout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijk Philips Electronics N. V., Eindhoven (NL)

(21) Appl. No.: 10/522,284

(22) PCT Filed: Jun. 26, 2003
(86) PCT No.: PCT/IB03/02819

§ 371 Date: Jan. 25, 2005

(30) Foreign Application Priority Data
Jul. 29, 2002 (EP) 02078100.1

(51) Int. Cl. G09G 3/28

(52) U.S. Cl. 345/67

(57) ABSTRACT

A three electrode PDP comprises a scan driver (SD) which supplies a substantially sine wave shaped voltage (VS) between first and the second scan electrodes (SEi, CEi), an amplitude of the substantially sine wave shaped voltage (VS) being large enough to sustain plasma cells (PCij), but being too small to ignite the plasma cells (PCij). A data driver (DD) supplies a substantially pulse shaped voltage (VD) to the data electrodes (DEi) for controlling an amount of light produced by the plasma cells (PCij). The sine wave shaped voltage may have a predetermined frequency such that more than one stable light output level is obtained.

The invention relates to a three electrode Plasma Display Panel (also referred to as PDP), a PDP apparatus comprising such a PDP, and a method of driving such a PDP.

Known three electrode PDP's comprise address or data electrodes extending in the column direction and parallel arranged first and second scan electrodes extending in the row direction to obtain a matrix of plasma cells associated with intersections of the address electrodes and the scan electrodes. The first and second scan electrodes are often referred to as scan electrodes and common electrodes, respectively. Therefore, in the following, whenever the term scan electrodes is used, both the first and second scan electrodes are meant.

Usually, to obtain display of gray scales, subfield addressing is applied: a field comprises several subfields. Each subfield comprises an addressing phase and a sustain phase. During the addressing phase the rows of plasma cells are selected one by one by supplying suitable voltages to adjacent ones of the first and the second scan electrodes. The voltages on the data electrodes (at the moment of selection) determine a charge stored in the selected row of plasma cells. During the succeeding sustaining period, a sustain voltage is supplied to all plasma cells. The charge stored during the preceding addressing phase determines whether a plasma cell will generate light during the sustaining period.

In most currently available PDP's, the sustain voltage consists of rectangular pulses. Usually, these voltage pulses have an amplitude of about 150 to 200 Volts, slopes lasting about 300 nanoseconds, and a repetition frequency of about 50 to 250 kHz. Although these rectangular pulses provide large margins and a high discharge efficiency, a high amount of Electro-Magnetic Interference (also referred to as EMI) is produced. Consequently, cumbersome measures are required to lower the EMI to acceptable levels.

Both U.S. Pat. No. 5,674,533 and US-B-6,369,514 disclose three electrode displays and their driving.

It is an object of the invention to provide a PDP which causes less EMI.

A first aspect of the invention provides a PDP as claimed in claim 1. A second aspect of the invention provides a PDP apparatus comprising such a PDP as claimed in claim 10. A third aspect of the invention provides a method of driving a PDP as claimed in claim 11. Advantageous embodiments are defined in the dependent claims.

The three electrode PDP in accordance with the invention comprises a scan driver which supplies a substantially sine wave shaped voltage between the first and the second scan electrodes during sustaining/during at least part of the frame time. The amplitude of the substantially sine wave shaped voltage is large enough to sustain plasma cells, but is too small to ignite the plasma cells. The data driver supplies a substantially pulse shaped voltage to the data electrodes for controlling the amount of light produced by the plasma cells.

The relatively high amplitude of the substantially sine wave shaped voltage (it is able to sustain ignited plasma cells) allows a relatively low amplitude of the substantially pulse shaped voltage. Only a relatively small supplemental voltage is required to change the state of a plasma cell.

For the sake of simplicity the substantially sine wave shaped voltage is also referred to as the sine wave and the substantially pulse shaped voltage is referred to as pulse. The sine wave need not be an exact algebraic sine wave, a wave form resembling an algebraic sine wave is sufficient to lower the EMI considerably compared to the prior art rectangular pulses. The most relevant issue is that the slopes of the sine wave are less steep than the slopes of the rectangular pulses used in the prior art. The low amplitude pulse will not considerably add to the amount of EMI produced. This is especially the case as the addressing occurs for one line at a time, while the sustaining occurs for the whole display.

In an embodiment as defined in claim 2, the instant of occurrence of the pulses with respect to the sine wave determines the state to which a cell will switch. Compared to the usual rectangular pulse drive which is able to produce on and off states of the plasma cells only, the two different light levels obtained in accordance with this embodiment of the invention allow a higher number of grey levels at a same number of subfields. Further, it is possible to change the state of a plasma cell during sustaining. The substantially pulse shaped voltage is supplied during the substantially sine wave shaped voltage which has an amplitude large enough to sustain the plasma cells. Thus, the embodiment as defined in claim 2 provides a real address while sustain drive of a PDP. This has the advantage that a higher light output of the PDP is possible because no time is lost for addressing the plasma cells before sustaining them.

In an embodiment as defined in claim 3, a possibility to select plasma cells in one of the rows is defined. The plasma cells in rows to which the substantially sine wave shaped voltage with superimposed scan pulse voltage is supplied will not be addressed because the polarity and amplitude of the scan pulse voltage are selected to compensate for the substantially pulse shaped voltages supplied to the data electrodes. The plasma cells in rows to which the substantially sine wave shaped voltage without the superimposed scan pulse voltage is supplied will be addressed due to the substantially pulse shaped voltages supplied to the data electrodes.

In an embodiment as defined in claim 4, another possibility to select the plasma cells in one of the rows is defined. The plasma cells in rows to which the substantially sine wave shaped voltage without the superimposed scan pulse voltage is supplied will not be addressed due to the substantially pulse shaped voltages supplied to the data electrodes. This because the amplitude of the substantially pulse shaped voltages is selected too low to be able to select the plasma cells. The plasma cells in rows to which the substantially sine wave shaped voltage with superimposed scan pulse voltage is supplied will be addressed, because the polarity and amplitude of the scan pulse voltage are selected to add to the substantially pulse shaped voltages supplied to the data electrodes such that the total voltage is large enough to select the plasma cells.

In an embodiment as defined in claim 5, the substantially sine wave shaped voltage supplied to the first scan electrode and the substantially sine wave shaped voltage supplied to the second scan electrode are phase shifted with respect to each other in a range of about 120 to 150 degrees. This has the advantage that a lower amplitude of the substantially pulse shaped voltages supplied to the data electrodes is possible, decreasing the amount of EMI produced.

An embodiment as defined in claim 6 provides a so called clear-addressing scheme combined with three level (off, first light level, second light level) drive. This combination provides an unexpected higher number of gray levels than the usual clear addressing scheme with two level (off, on) drive.

An embodiment as defined in claim 7 provides a inverse-clear-addressing scheme combined with three level drive. This combination provides an unexpected higher number of gray levels than the usual inverse-clear-addressing scheme with two level drive.

An embodiment as defined in claim 8 provides a circuit with two controllable electronic switches to generate the substantially sine wave shaped voltage. In this embodiment, the power is drawn from the DC power supplies, and the rising and descending slopes of the substantially sine wave shaped voltage have the same shape.

An embodiment as defined in claim 9 provides a circuit with a single controllable electronic switch to generate the substantially sine wave shaped voltage. In this embodiment, the power is drawn from the resonant circuit instead of the DC power supplies, and the rising and descending slopes of the substantially sine wave shaped voltage do not have the same shape, but the circuit is less expensive than the circuit with two controllable electronic switches.

These and other aspects of the invention are apparent from and will be elucidated with reference to the embodiments described hereinafter.

In the drawings:

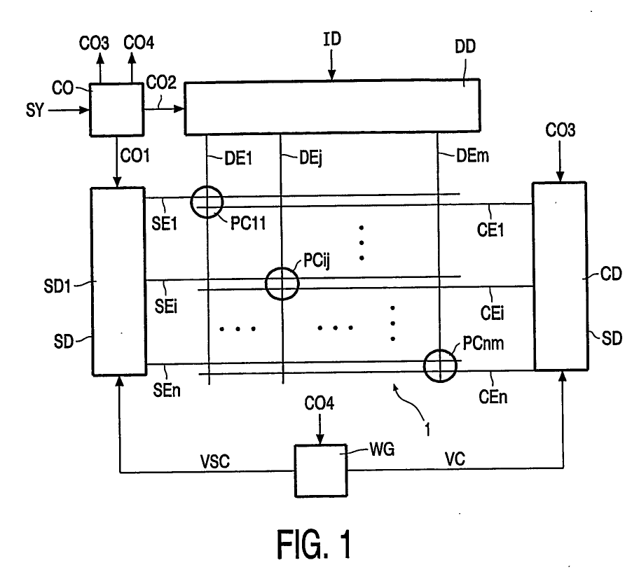

FIG. 1 shows a block diagram of a plasma display apparatus,

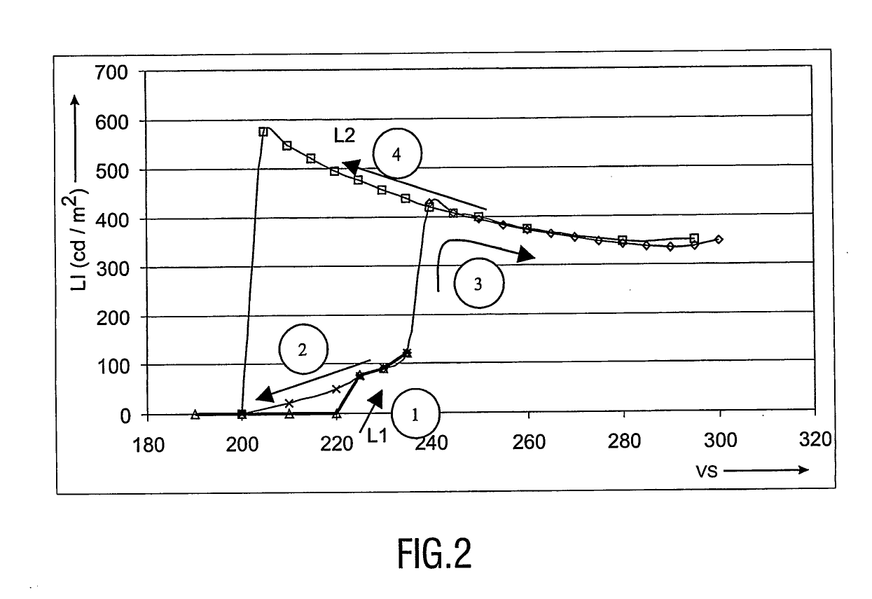

FIG. 2 shows graphs indicating the light output of a plasma cell at different amplitudes of the substantially sine wave shaped voltage to elucidate the three stable light levels,

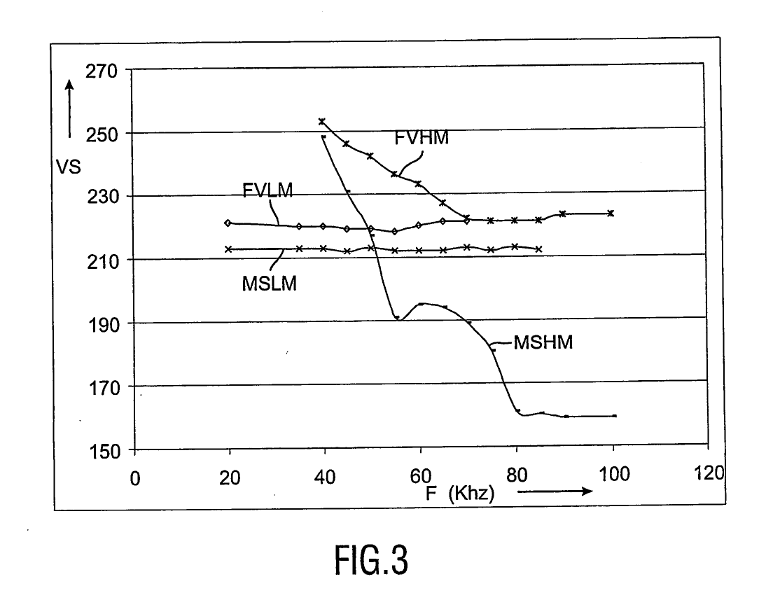

FIG. 3 shows graphs indicating voltage margins for changing the light output of the plasma cells between the three stable levels,

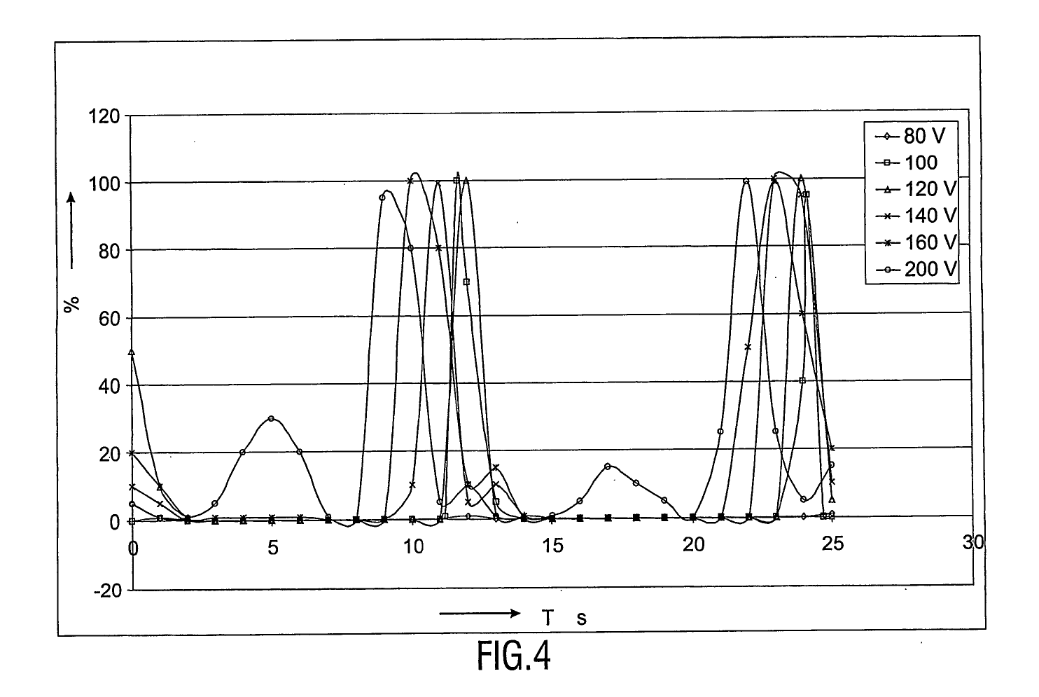

FIG. 4 shows graphs indicating the effect on a transition of the light output from the second to the first amount of light output of the instant of occurrence of the substantially pulse shaped voltage on the address electrodes with respect to the substantially sine wave shaped voltages on the scan electrodes,

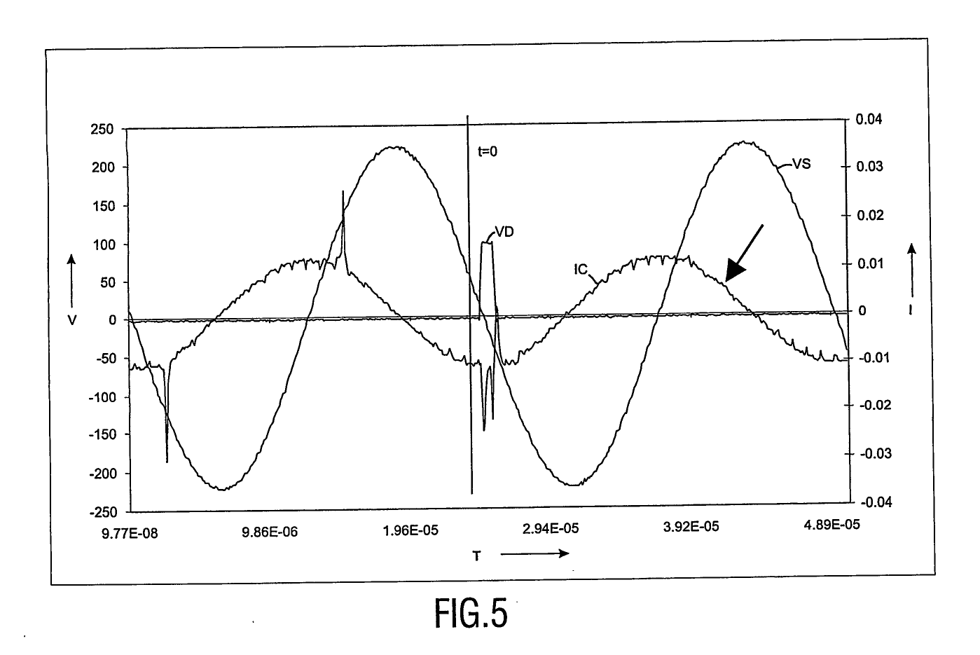

FIG. 5 shows signals elucidating the transition of the light output from the second to the first amount of light output,

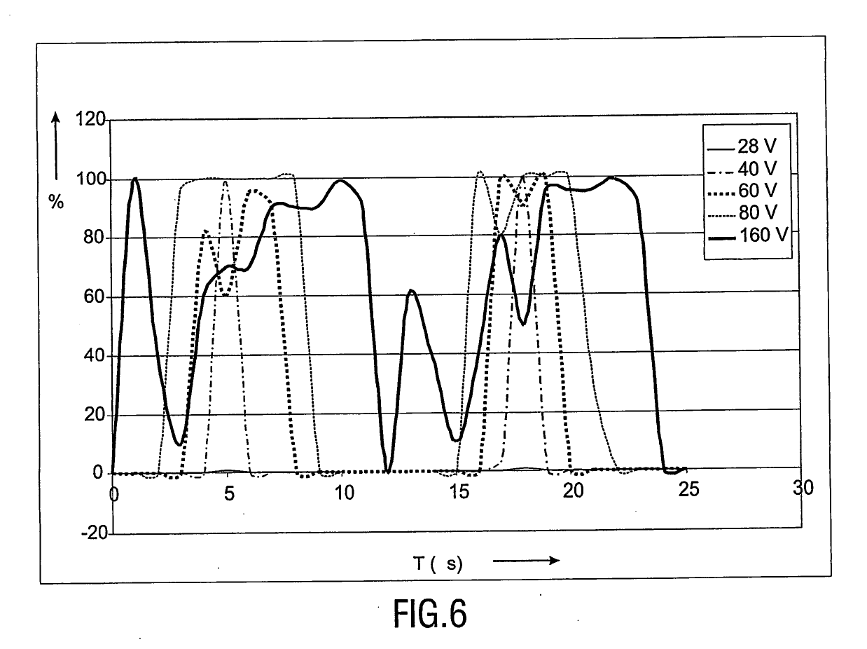

FIG. 6 shows graphs indicating the effect of the instant of occurrence of the substantially pulse shaped voltage on the address electrodes with respect to the substantially sine wave shaped voltages on the scan electrodes on a transition of the light output from the first to the second amount of light output,

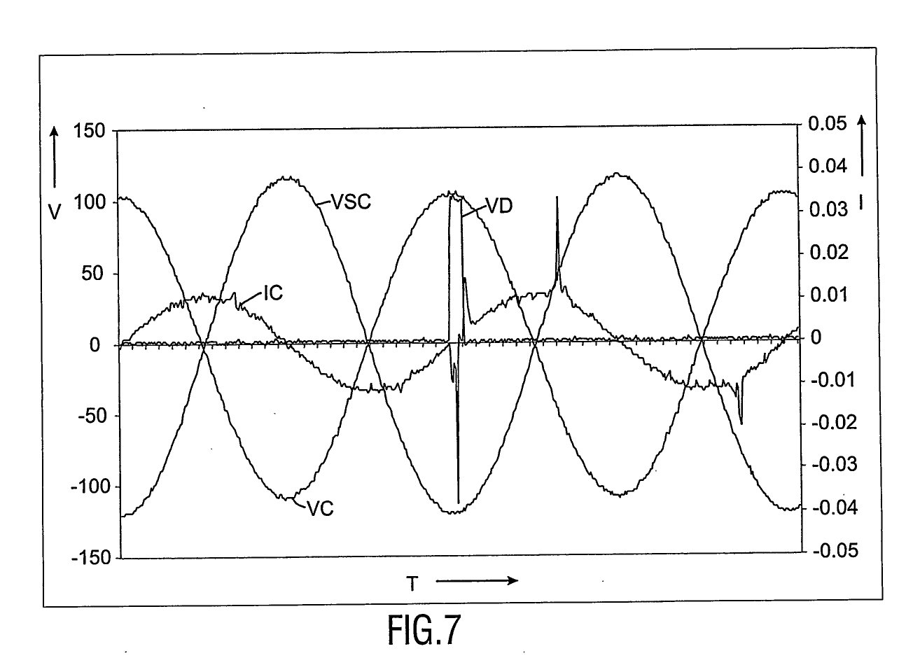

FIG. 7 shows signals elucidating the transition of the light output from the first to the second amount of light output,

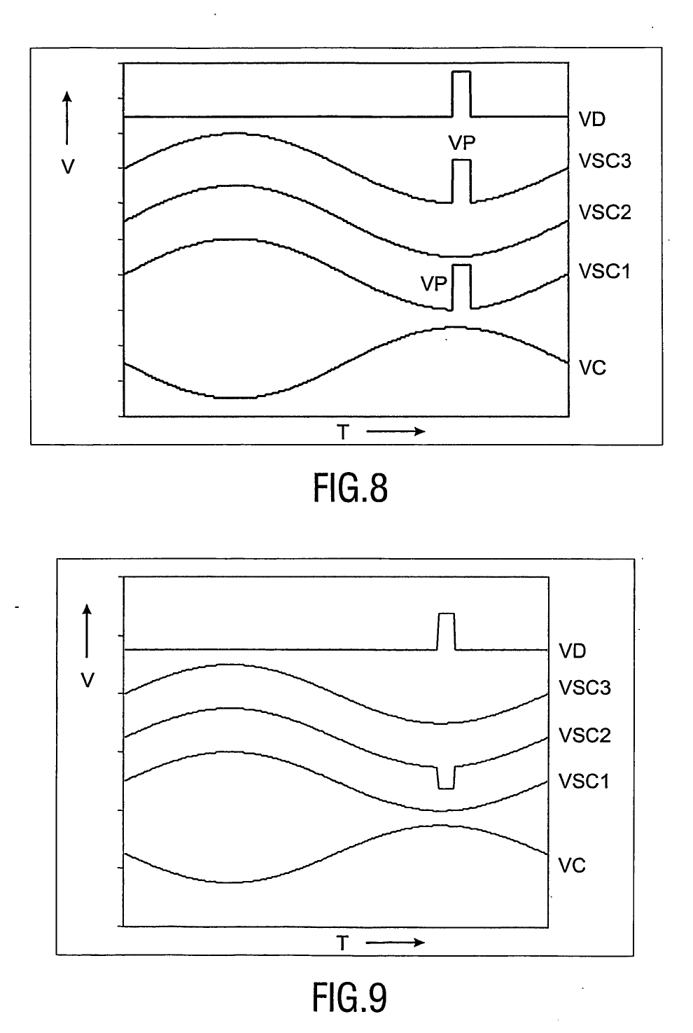

FIG. 8 shows signals elucidating the selection of a single row of plasma cells,

FIG. 9 shows signals elucidating the selection of a single row of plasma cells,

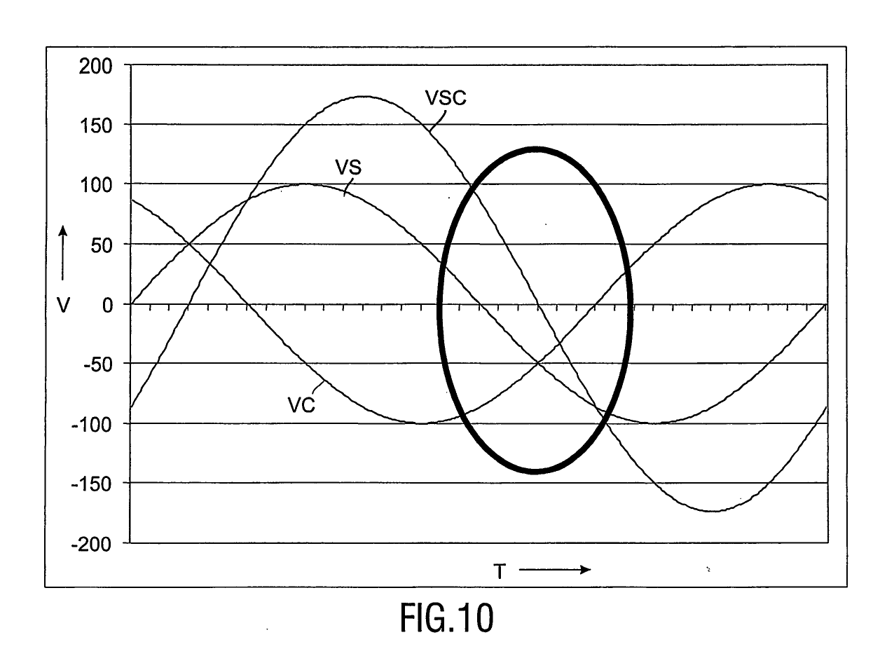

FIG. 10 shows signals elucidating a phase shift between the substantially sine wave shaped voltages supplied to the first and the second scan electrodes respectively,

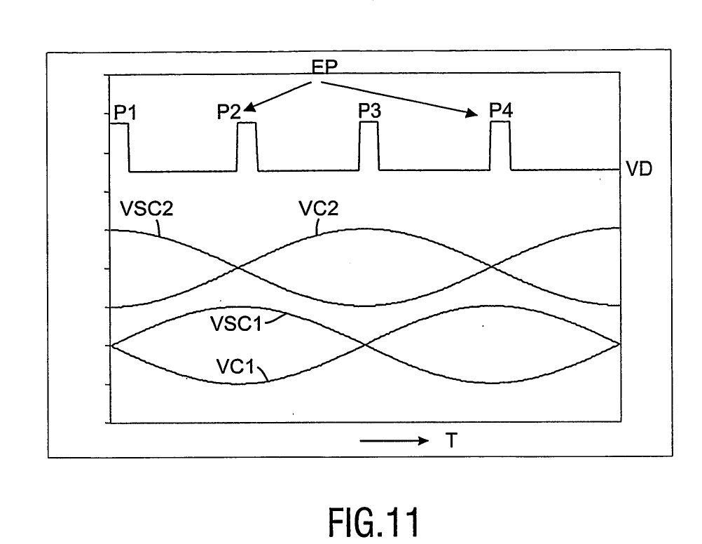

FIG. 11 shows signals elucidating phase shifted substantially sine wave shaped voltages which are supplied to different groups of scan electrodes,

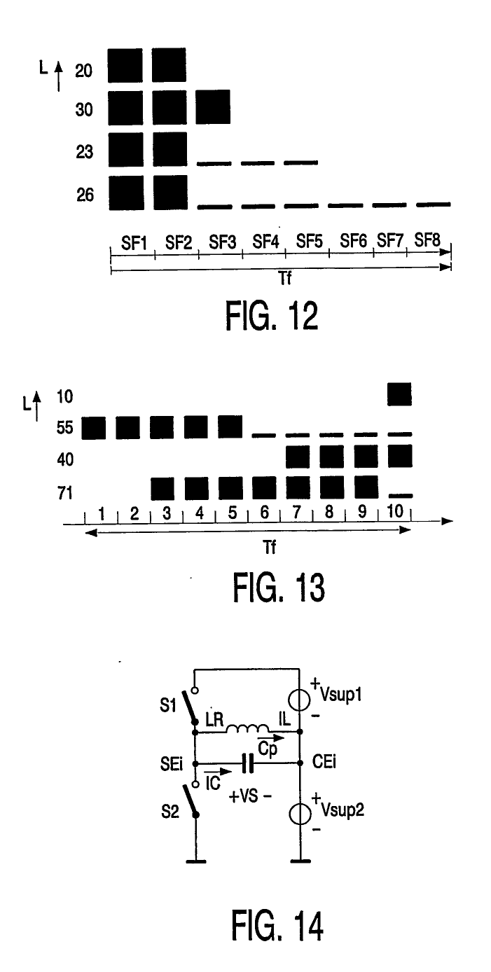

FIG. 12 shows a combination of a clear-addressing scheme and three level driving,

FIG. 13 shows a combination of an inverse-clear-addressing scheme and three level driving,

FIG. 14 shows a circuit for generating the substantially sine wave shaped voltages,

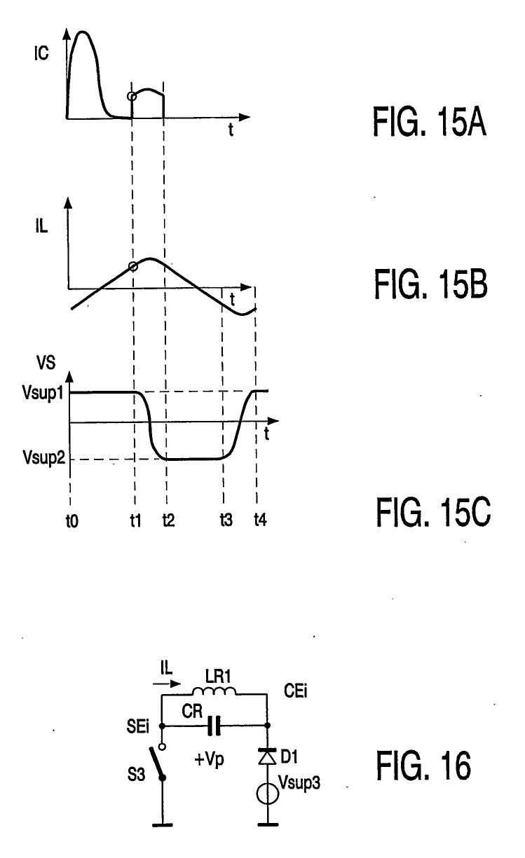

FIG. 15 show waveforms elucidating the operation of the circuit shown in FIG. 14,

FIG. 16 shows a circuit for generating the substantially sine wave shaped voltages, and

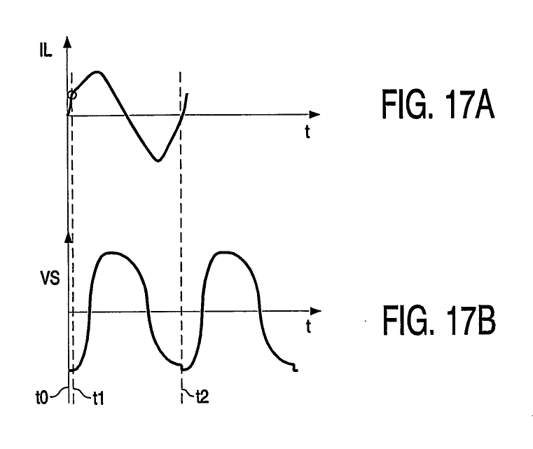

FIG. 17 show waveforms elucidating the operation of the circuit shown in FIG. 16.

In different figures, the same references refer to the same elements performing the same function.

FIG. 1 shows a block diagram of a plasma display apparatus.

The plasma display apparatus comprises a Plasma Display Panel (PDP) 1, a data driver DD, a scan driver SD which comprises a first scan driver SD1 which usually is referred to as scan electrode driver, and a second scan driver CD which usually is referred to as common electrode driver, a controller CO, and a waveform generator WG.

The known three electrode plasma display panel 1 comprises first scan electrodes SE1 to SEn, further referred to as SEi, second scan electrodes (also referred to as common electrodes because the electrodes are interconnected either in groups or all) CE1 to CEn, further referred to as CEi, data electrodes DE1 to DEm, further referred to as DEj, and plasma cells PC11 to PCnm, further referred to as PCij.

The first scan electrodes SEi and the common electrodes CEi are arranged substantially parallel. Neighboring first scan electrodes SEi and common electrodes CEi are associated with the same plasma cells PCij. Usually, the plasma cells PCij are not physically separated but are areas in a plasma channel. The plasma channel is associated with the neighboring first scan and the common electrodes SEi and CEi. The areas forming the plasma cells PCij are associated with the neighboring first scan electrodes and common electrodes SEi and CEi and a crossing data electrode DEj. The data electrodes DEj are arranged substantially perpendicular with respect to both the first scan electrodes SEi and the common electrodes CEi.

The first scan driver SD1 supplies scan voltages VSC (received from the waveform generator WG) to the first scan electrodes SEi. The common driver CD supplies a common voltage VC (received from the waveform generator WG) to the common electrodes CEi. The voltage VS between the first scan electrodes and the second scan electrodes or common electrodes is the subtraction of the scan voltage VSC and the common voltage VC. The voltage VS which is present across the plasma cells PCij is also referred to as the panel voltage VS. The common driver CD may supply the same common voltage VC to all the common electrodes CEi, or to groups of the common electrodes CEi. The data driver DD receives input data ID to supply data voltages to the data electrodes DEj.

A controller CO receives synchronization signals SY belonging to the input data ID to supply a control signal CO1 to the first scan driver SD1, a control signal CO2 to the data driver DD, a control signal CO3 to the common electrode driver CD, and a control signal CO4 to the waveform generator WG. The controller CO controls the timing of the pulses and the signals supplied by these circuits.

The operation of a known plasma display apparatus is elucidated in the now following.

During an addressing period of the plasma display panel 1, the plasma rows usually are ignited one by one. An ignited plasma row has a low impedance. The data voltages on the data electrodes DEj determine the amount of charge in each of the plasma cells PCij (the pixels) associated with the data electrodes DEj and the low impedance plasma channel. A pixel PCij preconditioned by this charge to produce light during the sustain period succeeding the addressing period will produce light during this sustain period. A plasma channel which has a low impedance is further referred to as a selected line or row (of plasma cells or pixels). During the addressing phase, the data voltages to be stored in the pixels PCij of a selected line are supplied line by line by the data driver DD.

During the sustaining phase, the first scan electrode driver SD1 and the common electrode driver CD supply scan pulses and common pulses, respectively, to all the lines. The pixels pre-charged to lit will produce light each time the associate plasma cells PCij are ignited. A plasma cell PCij will be ignited when it is pre-charged to do so and the sustain voltage supplied across the plasma cell PCij by the associated first scan electrode SEi and common electrode CEi reaches a sufficient amount. The number of ignitions determine the total amount of light produced by a pixel PCij.

In a practical implementation, the sustain voltage comprises rectangular pulses of alternating polarity. The voltage difference between scan and common pulses is selected to ignite the plasma cells PCij pre-charged to produce light, and to not ignite the plasma cells PCij pre-charged to not produce light.

The invention is directed to the waveform generator WG which provides a scan voltage VSC and a common voltage VC such that the panel voltage VS between the first scan electrodes SEi and the second scan electrodes or common electrodes CEi is a substantially sine wave shaped voltage. The amplitude of the substantially sine wave shaped voltage VS is large enough to sustain plasma cells PCij, but is too small to ignite the plasma cells PCij. The data driver DD supplies substantially pulse shaped voltages VD to the data electrodes DEj to control the amount of light produced by the plasma cells PCij.

The relatively high amplitude of the substantially sine wave shaped voltage (it is able to sustain ignited plasma cells) VS allows a relatively low amplitude of the substantially pulse shaped voltage VD. Only a small supplemental voltage is required to change the state of a plasma cell. The amount of EMI produced by the substantially sine wave shaped voltage VS (and the pulse voltage VD) will be relatively low compared to the substantially square wave shaped voltages used in the prior art.

The substantially sine wave shaped voltage VS across the plasma cells PCij need not actually be generated as two separate waveforms. The wave form generator may generate the voltage VS a single waveform.

It is possible to use the known subfield drive wherein in each subfield, first the plasma cells PCij are selected (primed to produce yes or no light during the subsequent sustain period) and then the PDP is sustained with the substantially sine wave shaped voltage VS.

It is also possible to select the plasma cells PCij during the sustaining with the substantially sine wave shaped voltage VS. Embodiments of such an address while sustain drive are claimed in claims 2, 3 and 4. Claim 2 is directed towards changing the state of the plasma cells PCij between the first amount of light output L1 and the second amount of light output L2 or the other way around during the sustaining by the substantially sine wave shaped voltage VS. The state of the plasma cells PCij is changed by controlling the instant of occurrence of the applying a pulse shaped voltage-VD with the right amplitude and timing on the data electrodes DEj. Claims 3 and 4 are directed to the selection of a single row of plasma pixels. Or said in another way, the pulse shaped voltage VD on the data electrodes DEj influences the plasma cells PCij of a single row only. This allows an address while sustain drive of the PDP which addresses (and, if required changes the state of) the plasma cells PCij row by row. The address while sustain drive of the PDP has the advantage that a separate addressing period is not anymore required and a substantially amount of time becomes available which, for example, may be used to enlarge the light output, To conclude, most current commercial PDP's are sustained with square wave shaped voltages. This is a straightforward manner to generate discharges and thus emit light. Some advantages of the square wave shaped voltages are the relative easy to develop electronics and the use of only one single voltage, which is applied to the scan and common electrode in alternation. The achieved sustaining margins are also quite good. However, a disadvantage of square waves is that the steep slopes of it are responsible for severe problems with respect to EMI, hence shielding of the EMI is absolutely necessary. A significant part of the cost of PDP's is caused by precautions required to keep the EMI produced within the (often governmental) limits.

The invention is directed towards the use of substantially sine wave shaped voltages VS on or between the first and second scan electrodes SEi and CEi. Many variations are possible; all aim to reduce the steep slopes of the usual square waves. These variations are found in a number of variables such as the frequency of the sine wave VS used and whether some additional step is applied on top of the sine wave VS. The pulse shaped voltages VD on the data electrodes DEj determine the state of the plasma cells PCij (no light, light). The use of substantially sine wave shaped voltages VS on the scan electrodes SEi and CEi and pulse shaped voltages VD on the data electrodes DEj is further referred to as sine wave drive.

Usually, a PDP consists of two glass plates with a mixture of Neon and Xenon in-between. Usually, the scan electrodes SEi and CEi extend in the horizontal direction and the data electrodes DEj extend in the vertical direction. In accordance with the invention, the two scan electrodes SEi and CEi and the data electrodes DEj are driven to ignite and sustain a discharge in the plasma cells PCij, which discharge produces ultra-violet light. This light hits a phosphor, which in turn emits visible light in one of the three primary colors. The sine wave drive in accordance with the invention and its embodiments is experimentally checked on a 6″ test panel, which has the characteristics in the table below. These values are quite similar to a full size 42″ commercial panel.

| Parameter | Value |
|---|---|
| Vertical pitch (μm) | 1080 |
| Horizontal pitch (μm) | 360 |
| Gap width (μm) | 60 |
| Sustain electrode width (μm) | 300 |
| Channel depth (μm) | 170 |
| Capacitance (nF/cm2) | 0.45 |
| Xe concentration (%) | 3.5 |
| Gas pressure (mbar) | 650 |

A definition of the wall charge, the fire voltage, and the minimum sustain voltage in a PDP is given in the now following.

The wall charge of a plasma cell (further referred to as cell) PCij is caused by discharges which take place within the cell PCij. Due to the discharge, positive and negative particles are formed. These particles tend to stick to the walls of the cell PCij, thus causing an (extra) electric field across the cell PCij. The lifetime of these particles may be up to several hundreds of milliseconds.

The fire voltage is a (scalar) property of any cell PCij. When a cell PCij is in the OFF-state no current flows and no light is emitted. When increasing the voltage over the cell PCij, a sudden and sharp increase in the current occurs. At the same time light emission starts. Hence the fire voltage can be determined fairly easy, by increasing the voltage across the cell PCij until light is seen. In complex waveforms one must keep in mind that wall charge from previous discharges may influence the observed (externally applied) fire voltage.

Once a cell PCij is in the ON-state, in AC driven plasma displays, a lower voltage than the fire voltage is sufficient to maintain a discharge. This is due to wall charges from previous discharges which provide a part of the required field across the cell PCij. Hence a smaller external voltage, the minimum sustain voltage, is required to build up a field large enough for a subsequent discharge of the cell PCij.

The difference between the fire voltage and the minimum sustain voltage is called the sustaining margin. A large sustaining margin is a sound property of a PDP, as this makes it easier to sustain and address a (large) panel with a voltage suitable for all pixels.

FIG. 2 shows graphs indicating the light output of a plasma cell PCij at different amplitudes of the substantially sine wave shaped voltage VS to elucidate the three stable light levels (no light, a first and a second amount of light output).

It appeared that the sine wave drive at the correct frequency and amplitude of the substantially sine wave shaped voltage VS allows a multi-level driving. This means that in contrary to the usual square wave operation, a pixel has three stable states instead of only two. Whereas in normal operation a pixel is either on or off, in multi-level driving it also has a dim state of light emission. The different light emitting states can be selected by addressing the cells PCij with a very short pulse of a few hundred nanoseconds on the data electrode DEj. A pixel can be switched from the high to the low mode, and vice versa depending on the timing of the pulse with respect to the substantially sine wave shaped voltage VS. This switching may be performed during sustaining, thus a subfield-like setup is not necessary, and new addressing schemes are possible.

In an embodiment of the invention, the substantially sine wave shaped voltage VSC supplied to the first scan electrodes SEi (further referred to as the first sine wave VSC) and the substantially sinewave shaped voltage VC supplied to the second scan electrodes (or common electrodes) CEi (further referred to as the second sine wave VC) are opposite in phase. Slight deviations from a pure sine wave shaped voltage will still incorporate multi-level effects. In a preferred embodiment, the amplitudes of the first and second sine wave VSC, VC are equal because this is easy to implement, but this is not necessary for the operation of the PDP in accordance with the invention.

In the sustaining mode, which is also an address mode, the phase between the pulse VD on the data electrodes DEj on the one hand and the first and second sine wave VSC, VC on the other hand, is not important. Only when addressing a panel, this phase will make a difference, as the pulse VD on the data electrodes DEj will have an effect that depends on its phase with respect to the voltage VSC on the first electrodes SEi, but also on its phase with respect to the panel voltage VS. This panel voltage VS is defined as the voltage difference between the voltage VSC on the first electrodes SEi and the voltage VC on the common electrodes CEi.

In FIG. 2 the light output LI is shown as function of the panel voltage VS at a frequency of 50 kHz of the first and second sine wave VSC and VC. The absolute values of the light output LI, the frequencies and the panel voltages VS are valid for the 6″ test panel used and may be different for other panels. Two different fire voltages appear to exist. At a panel voltage VS amplitude of 220 volts, the panel fires from the OFF state to a light emitting state (indicated by an encircled 1) with a luminance just below 100 Cdm-2. If instead the voltage VS is decreased (the arrow indicated by 2) the light level slowly dims until the minimum sustain voltage is reached, after which light emission stops. If now the sustain voltage VS is further increased to 240 volts, the plasma cell PCij will ‘fire’ again (see the steep rise of the light output indicated by the vertical part of the arrow 3) to about 400 Cdm-2. When decreasing the voltage VS in this situation, the light level will even increase (see the arrow indicated by 4) to above 500 Cdm⁻², before it suddenly reaches the minimum sustain voltage and the cell PCij turns off. When considering the cell PCij states at a voltage VS with an amplitude of 210 volts, three different light levels can be obtained. Depending on the history of the cell state, light levels of about 0, 50 and 500 Cdm-2 are possible. This is a three-level operation of a plasma cell PCij.

FIG. 3 shows graphs indicating voltage margins for changing the light output of the plasma cells PCij between the three stable levels. In FIG. 3 the graph indicated by FVLM is the fire voltage of the low light output mode (further referred to as the low mode or the dim mode), the graph indicated by MSLM is the minimum sustain voltage of the low mode, the graph indicated by FVHM is the fire voltage of the high light output mode (further referred to as the high mode or bright mode), and the graph indicated by MSHM is the minimum sustain voltage of the high mode.

In the test panel used, the fire- and minimum sustain voltages for the low level mode are almost perfectly independent of the frequency of the sustain voltage VS. The high level mode however shows a very strong decrease in both voltages FVHM and MSHM as function of the frequency F. The minimum sustain voltage MSHM drops by almost 100 volts, over a range of 40 kHz. The sustaining margin remains constant at higher frequencies.

Three separate regions can be distinguished.

Below 50 kHz the PDP cells PCij fire in the dim light-level mode when increasing the amplitude of the sine wave shaped voltage VS from zero. At higher amplitudes of the voltage VS, all pixels PCij switch from the dim mode to the bright mode. Now, when the amplitude of the voltage VS is decreased again, the pixels revert back to the dim mode, as the minimum sustain voltage of the bright mode MSHM is above the minimum sustain level of the dim level MSLM. Once this last voltage level is reached, all pixels turn off. In this frequency region the three light levels do not exist simultaneously. Either the voltage VS is above the fire voltage of the low level mode FVLM, which means there is no OFF state, or the voltage VS is below the minimum sustain voltage of the high mode MSHM, which means there is no high mode.

Above 70 kHz the PDP cells PCij will fire directly in the bright mode when increasing the amplitude of the sine wave shaped voltage VS from zero, as the bright mode fire voltage FVHM drops to the same level as the dim mode fire voltage FVML. The dim mode does still exist however. By firing the PDP at a lower frequency of the voltage VS, the cells PCij will ignite in the low level mode. When the amplitude of the voltage VS is reduced to a value below the fire voltage of the high level mode FVHM, the frequency of it can be increased a little. Now the minimum sustain voltage of the dim level mode MSLM at this higher frequency can be measured. However, due to this cumbersome procedure, for practical purposes, the low level mode can be regarded as non-existent.

Only in the region between 50 and 70 kHz true three level operation can be achieved as a voltage/frequency window exists which is below both fire voltages and above both minimum sustain voltages. The state of the cell PCij can be selected by an appropriate series of amplitude sequences of the voltage VS. Assuming the cell is in the OFF-state, it will remain in that state when the amplitude of the voltage VS is selected below the minimum sustain voltage of the high mode MSHM. By raising the amplitude of the voltage VS above the fire voltage FVLM and back again, the pixel PCij will switch to the dim mode. By increasing the amplitude of the voltage VS even higher until it crosses the fire voltage FVHM of the high mode, and then back into the window between the fire voltage FVMH and the minimum sustain voltage MSHM, the pixel PCij will change into and stay in the bright mode.

In a practical PDP panel some variation in the previously mentioned voltage levels is present between individual pixels PCij. This tolerance in the voltage levels required decreases the window in which the dim mode is addressable (the area between the fire voltages FVLM and FVHM which enable to active the dim mode but not the bright mode, and the area between the fire voltage FVLM and the minimum sustain voltage MSLM of the dim mode which allows a stable dim mode). In the non-optimized test panel a voltage margin of a few volts appeared to be present.

The possibility to switch between different levels within a multi-level setup is of great importance. Several options exist to achieve a transition between different states, although some are easier to implement in drive schemes than others. Because of the multi-level effect an addressing scheme with less subfields could be used. Whereas eight subfields in an on/off setup provide a maximum of 256 grey levels (assuming binary subfield weights), just five subfields are necessary for 243 grey levels in a three level setup. Eight subfields in a ternary setup will provide for the huge amount of 59049 grey levels. In practice some of these gray levels will overlap each other.

A first method of addressing the cells PCij in a three level way is by variation of the amplitude of the sustain voltage VS. As shown in FIG. 3 a straightforward method exists to switch between modes. As the fire voltage and minimum sustain voltage are different for both modes, this can be exploited to change levels. Regardless of frequency, all cells in the panel will end up in the high level mode if the amplitude of the voltage VS is increased sufficiently. In the frequency range where the low level mode does exist, all cells will first fire in the low level mode, assuming they are in the off state. This outlines the simple method: raise the amplitude of the sustain voltage VS high enough to fire all cells PCij into the desired mode, or decrease the amplitude of the voltage VS enough to turn off the cells PCij. Increase the amplitude of the voltage VS just a little to fire the cells PCij in the dim mode. Although this method is quite easy and reliable, it has one disadvantage. All operations apply to all pixels PCij on a single sustain line simultaneously. Real addressing requires that individual pixels PCij can be addressed, so a method that only works on entire lines is only useful in special circumstances: for example, an erase sequence or alike, when all cells should be erased simultaneously. Another option could be a priming pulse, which also is not pixel selective. All other image-forming operations should be applied to single pixels PCij, which almost automatically leads to methods involving the third electrode which is the data electrode DEj.

A second method of three level addressing of the cells PCij uses well timed pulses VD on the data electrode DEj. A pulse VD on the data electrode DEj may cause a discharge, thus altering the wall charges present in a cell PCij. Although in the FIGS. 5 and 7 square pulses VD are shown, other shapes function as well. This pulse VD can vary in amplitude, duration and starting phase with respect to the sine wave shaped sustaining voltages VS on scan and common electrodes SEi and CEi. Whether the pulse VD on the data electrode DEj causes a discharge, and what happens to the state of a cell PCij depends not only on the pulse VD itself, but also on the state of the cell PCij before the pulse VD. Possible consequences of supplying the pulse VD are: nothing happens, the cell PCij switches to the high mode regardless of its state before the pulse VD, the cell PCij switches to the low mode regardless of its state before the pulse VD, the cell PCij switches off regardless of its state before the pulse VD, the cell PCij switches on either in the high or low mode, or the cell PCij switches between modes depending on its state before the pulse VD (for example, a cell in the low mode switches to the high mode, and vice versa, or a cell switches on and off).

It is desirable to keep the length of the pulses VD as short as possible to minimize the time required for addressing, especially in the usually used subfield drive schemes. In normal subfield schemes with a separate addressing phase and sustaining phase, about 50-70% of the total frame time is used for addressing, thus leaving little time for actual light emission during the sustaining phase. With this effect in mind, the result of square data pulses VD of about 1 μs length has been studied. Within these boundaries, the amplitude and phase of the pulses VD with respect to the panel voltage VS can still be varied. Whether these pulses VD have any effect is shown in FIGS. 4 and 6. In both these Figs., the percentage of pixels PCij responding correctly to a certain pulse VD on the data electrode DEj is depicted. Only when the success rate equals 100%, the entire PDP responds correctly. An area of cells PCij of 8 lines time 20 columns has been used for these experiments. In both FIGS. 4 and 6, the time T in microseconds is plotted along the horizontal axis. The indicated instants are the starting instants of the pulse VD on the data electrode DEj with respect to the zero crossing of the sine wave voltage VS across the cell PCij. In both FIGS. 4 and 6, the PDP panel was sustained with a continuous sine wave on both the first and second scan electrodes SEi and CEi. The frequency of both sine waves is 40 kHz, the peak-to-peak voltage of both sine waves is 210 volts, and they are phase shifted over 180 degrees. The pulse VD on the data electrode DEj is a rectangular pulse with a duration of 1 microsecond.

FIG. 4 shows graphs indicating the effect of the instant of occurrence of the substantially pulse shaped voltage VD on the data electrodes DEj with respect to the substantially sine wave shaped voltages VSC and VC on the scan electrodes SEi and CEi on a transition of the light output from the second (L2) to the first (L1) amount of light output. The vertical axis shows the success rate as a %, and thus indicates the percentage of cells which switch from the high to the low mode.

From FIG. 4 can be concluded that in a small time slot, for example, at around 10 microseconds, a data pulse VD with sufficient amplitude is quite effective in switching pixels PCij from the high mode to the low mode. A conclusion is that, for the test panel, a data voltage VD of about 100 volts is enough to switch pixels PCij from the high mode to the low mode.

FIG. 5 shows signals elucidating the transition of the light output from the second L2 to the first L1 amount of light output. FIG. 5, shows the sine wave voltage VS across the cell PCij, the pulse voltage VD on the data electrode DEj and the current IC through the cell PCij.

A strong discharge is observed twice each period as peaks in the current IC. The light emission is accordingly strong, the cell PCij is in the bright mode. The pulse VD on the data electrode DEj is applied more or less during a current peak, and has an immediate effect on the type of discharge taking place. Already in the next sustaining period the strong ignition has disappeared, and a low-level ignition is visible (indicated by the arrow). This low-level ignition is difficult to see because of its relatively low amplitude. It can be concluded that the data pulse VD supplied at the shown instant with respect to the phase of the sine wave voltage VS is very successful in achieving the correct wall voltage to change from the bright mode to the dim mode.

Another important fact illustrated by FIG. 5 is that the switching of pixels PCij occurs during sustaining. Whereas known Address-While-Display (AWD) schemes in fact are Address-in-between-Display schemes, the addressing between multi-levels in accordance with the invention is truly Address-While-Display: the sustaining (by the sine wave) continues without any interruption at all when the addressing by the pulse VD takes place. This true AWD addressing allows sustaining a PDP panel with a 100 percent duty cycle, as the addressing can be done during the sustaining. If no addressing, i.e. a change of the pixel intensity, is necessary, a pixel can remain in the high mode indefinitely without any interruption.

FIG. 6 shows graphs indicating the effect of the instant of occurrence of the substantially pulse shaped voltage VD on the data electrodes DEj with respect to the substantially sine wave shaped voltages VSC and VC on the scan electrodes SEi and CEi on a transition of the light output from the first (L1) to the second (L2) amount of light output. FIG. 6 is very similar to FIG. 4, FIG. 6 shows when to apply the pulse VD on the data electrode DEj with which amplitude to allow a cell PCij to change its state from the low to the high mode, while FIG. 4 shows the changing from high to low mode. An absolute value of the voltage VD of 40 volts suffices to switch all pixels PCij of the PDP from the low mode to the high mode (provided the timing is right, for example: 5 microseconds).

FIG. 7 shows signals elucidating the transition of the light output from the first (L1) to the second (L2) amount of light output. Comparable to FIG. 5, FIG. 7 shows the voltage VS across the cell PCij but now as the first and second scan voltages VSC and VC as supplied to the first and second scan electrodes SEi and CEi, respectively. FIG. 7 further shows the pulse VD on the data electrode DEj, and the current IC through the cell PCij. Whereas the pulse voltage VD occurred just after the zero-crossing of the panel voltage VS in FIG. 5, now the pulse voltage VD occurs around the maximum of the panel voltage VS. The effect is about the opposite; the cell PCij switches instantly from the low mode (hardly visible spikes in the current IC before the pulse VD) to the high mode (clearly visible spikes in the current IC after the pulse VD).

FIGS. 4 to 7 are directed to switching a cell PCij from the dim to the bright mode, or the other way around. The switching of a cell PCij to either the off-state or the on-state is elucidated in the now following.

The cells PCij may easily be switched to the off-state in situations wherein no low mode exists (for example, at a frequency of the panel voltage VS that is either too low or too high). At such frequencies, a relatively large window of address voltages and phases appeared to be useful for turning off a pixel.

Switching a cell PCij to the on-state is similarly easy when no low mode exists. Experiments have shown that even a 1 Hz switching frequency between on and off states appeared to be no problem: all pixels PCij ignited without any problems. Most current addressing schemes use at least one priming pulse every frame, i.e. every 20 milliseconds. One of the advantages of this low switching frequency is the improved contrast because less priming pulses are required.

FIGS. 8 and 9 show signals elucidating the selection of a single row of plasma cells PCij. Both FIGS. 8 and 9 show from top to bottom: the pulse VD on the data electrode DEj, the voltage VSC3 on the third one SE3 of the first scan electrodes SEi, the signal VSC2 on the second one SE2 of the first scan electrodes SEi, the signal VSC1 on the first one SE1 of the first scan electrodes SEi, and the signal VC on the second scan electrodes SCi.

Constructing an entire addressing scheme requires a method to selectively address the pixels PCij. As explained before, applying a voltage pulse VD on the data electrode DEj can cause a pixel PCij to switch from one mode or state to another. However, a ‘correct’ pulse on the data electrode DEj will cause all pixels on the vertical column of the specific data electrode DEj to switch states. In practice, the state ofjust one pixel PCij on a vertical column should change, while leaving all other pixels in that column in their previous state.

Two different solutions to this problem are elucidated in the now following.

The first solution is to superimpose a pulse voltage VP on the sine wave VSCi supplied to one of the first or second scan electrodes SEi or CEi. This pulse voltage VP has the same amplitude and duration as the pulse VD supplied to the data electrode DEi for rows that should not be addressed. This is illustrated in FIG. 8 by the waveforms VSC1 and VSC3. In this situation, the voltage difference between the data electrode DEi and the first scan electrodes SE1, SE3 will remain below the fire voltage, and nothing will happen. No pulse is supplied to the rows which should be addressed, see the waveform VSC2. Thus, by applying the pulse also on one of the scan electrodes SEi or CEi, on all-but-one row, only the cells PCij of this single row will be affected by the data pulse VD and hence switch modes if required. It is a disadvantage that a pulse VP has to be superposed to all-but-one rows (500-700 in a normal panel, 1024 in an ALiS panel), because the electronics required will become complex.

The pulse VP may also be superposed on both the first and the second scan electrodes SEi and CEi such that a voltage VS between the first and the second scan electrodes SEi and CEi results in a pulse VP which has an amplitude and polarity such that the pulse VD on the data electrode DEj will not select the corresponding row of cells PCij.

The pulse VP may be generated as a separate signal and be added to the sine wave, for example by using a transformer. It is also possible to generate the sine wave comprising the pulse directly as a single signal.

A more convenient solution is shown in FIG. 9 wherein the amplitude of the data pulse DV is decreased to just below the fire voltage, hence nothing will happen in all rows. Now a pulse VP is added to a single row, with a polarity opposite to the polarity of the data pulse DV. Only on this row the voltage VS between the scan electrodes will exceed the fire voltage, and the pixel PCij will change modes. This line-select addressing has the advantage that only on the line being addressed, an extra pulse VP is required on the sustain electrodes SEi, CEi. It also has a disadvantage however. The amplitude required for the voltage VS between the sustain electrodes SEi, CEi has to increase. Whereas the extra pulse VP in FIG. 8 is positive (thus within the amplitude range of the sine wave), for the method elucidated with respect to FIG. 9 the scan driver SD1 must be capable to withstand or generate a higher voltage.

FIG. 10 shows signals elucidating a phase shift between the substantially sine wave shaped voltages VSC and VC supplied to the first and the second scan electrodes SEi and CEi, respectively, and the resulting panel voltage VS.

The substantially sine wave shaped voltages VSC and VC need not have a phase difference of exactly 180 degrees. In fact it has an advantage to have a smaller phase shift, for example, in the range of 120 to 150 degrees. This reduced phase shift allows lower data voltages VD, which in turn may result in cheaper electronics.

FIG. 10 shows the first scan and common sine wave VSC and VC with a phase shift of 120 degrees. The reduced data voltages VD can be explained best by the waveforms within the encircled part of FIG. 10. The first scan and common voltages VCS and VC are not equal to zero at the instant the panel (first scan-common) voltage VS is equal to zero. Because the panel ‘sees’ only the panel voltage VS, the wall charge depends only on this voltage. Consequently, the same applies to the timing of the data pulses VD to switch modes of the cells PCij. The data pulse VD however, discharges to either the first scan or common electrode SEi, CEi. Because at the instant of occurrence of the data pulse VD these voltages VCS and VC are not equal to zero anymore, the required data voltage VD is reduced: only the voltage difference between the data DBj and the first scan/common electrode SEi, CEi determines whether a (mode-changing) discharge takes place. In the test panel used, it appeared to be possible to decrease the amplitude of the data voltage VD with 50 volts.

A side effect of the reduced phase difference is that the maximum value of the panel voltage VS is also reduced. The amplitude of the first scan and common voltages VCS and VC should be increased a little bit such that the panel (cells PCij) receives the same amplitude of the sustain voltage VS. In this example, both the first scan and common voltage VSC and VC should be raised from 100 to 114 volt to keep the panel voltage VS maximum at 200 volts. Thus, a reduction of 50 volts in a high frequency data pulse VD can be exchanged by a 14 volts increase in the low frequency sine waves VSC and VC. This improves the EMI behavior considerably.

FIG. 11 shows signals elucidating phase shifted substantially sine wave shaped voltages which are supplied to different groups of scan electrodes SEi and CEi. From top to bottom are shown: the data voltage VD, the first scan voltage VSC2 and the common voltage VC2 for a second group of scan electrodes SEi and CEi, and the first scan voltage VSC1 and the common voltage VC1 for a first group of scan electrodes SEi and CEi.

The number of times all pixels PCij in an entire PDP display can be addressed is limited by a number of factors. A pixel PCij can be switched to certain states, only during predetermined time slots of the sine wave. In the trivial implementation, one line can be addressed each maximum and minimum of the panel voltage VS. Thus, at a sine wave frequency of 60 kHz, only 1200 periods are available each television frame (assuming 50 frames per second). This implies 2400 opportunities to switch a pixel PCij. When divided by 480 lines in a PDP, exactly 5 subfields are possible. Without multi-level driving, this results in six grey levels, with multi-level driving 21 levels are possible. This is a relatively low number of sub fields.

The phase shifted sine wave voltages for different rows (groups of scan electrodes SEi, CEi) provides more ‘time-slots’ for addressing the cells PCij and thus increases the number of available grey levels.

With respect to FIG. 11, because the data pulses P1 to P4 of the data voltage VD are only effective when applied at the right instant, for example at the zero crossing of the panel voltage VS, only the 1st and 3rd data pulse P1 and P3 will act on the first group of scan electrodes SEi and CEi (further referred to as line 1). Because the second group of scan electrodes SEi and CEi (further referred to as line 2) is not at the zero crossing of its panel voltage VS, nothing will happen on this line 2. The other way around, data pulses P2 and P4 will only cause pixels in line 2 to switch modes. In this way, double the amount of switching instants is available each period, and thus the amount of subfields doubles from 5 to 10.

In a practical situation, half of the lines will be in phase with line 1; the other half will be in phase with line 2. The division is not restricted however to two groups as elucidated with respect to FIG. 11. Depending on the exact data voltages VD and timing, more groups are possible. The only consideration is that a data pulse Pi intended for one group, does not act in any way on the other groups.

FIG. 12 shows a combination of a clear addressing scheme and three level driving.

Current commercial PDP panels usually are of the so-called Address Display Separated (ADS) type. All lines PCaj are addressed consecutively during an addressing phase, and subsequently light is emitted during the sustain phase. The result is that during the addressing phase, which is a substantial period of time within a frame Tf, no light is emitted.

The addressing used in sine wave driving in accordance with the invention influences the light emission of a pixel during the sustaining. Thus it is possible that pixels emit light during 100% of the time. However, sine wave driving in accordance with the invention may also be used in combination with the known ADS type drive of the PDP.

A known addressing scheme referred to as clear scheme operates as follows. At the start of the frame, all pixels PCij are ignited. This means they will all emit light in the following sub fields SFi. Immediately afterwards, all pixels PCij are addressed on a line at a time basis. Pixels PCij that have to remain dark will be turned off before the first sustain period starts. After the first sustain period, in which some of the pixels will have emitted light, all pixels PCij are addressed again. In this second addressing phase, pixels PCij that have already emitted sufficient light will be turned off for the rest of the frame time Tf. In this way some eight to twelve subfields SFi are generated. One of the problems is that pixels PCij can be off for quite some time (an entire frame). Hence a priming pulse is needed every frame period Tf, which deteriorates the contrast. Another problem is the low total amount of grey levels. The total number of grey levels that can be achieved with such a setup is equal to one more than the number of subfields SFi.

The three-level sine drive in accordance with the invention used in a clear like scheme greatly increases the number of available grey levels. Now, again, a frame period Tf will consist of a number of subfields SFi and addressing periods in which the state of pixels can be altered even during the sustaining phase. Surprisingly, the multi-level driving, with two different possible grey levels in one subfield SFi, increases the total number of grey 10 levels in an entire frame by far more than a factor of two. This will be elucidated in the now following.

It is assumed that the contribution to the light output of the high mode is a factor of ten greater than the contribution of the low mode, and that the clear scheme has ten subfields SFi. A prior art clear drive scheme would provide the 11 relative grey levels of 0, 10, 20, . . . ,100. The availability of a low mode in sine wave driving in accordance with the invention allows much more grey levels. For example, grey levels 1 to 9 are generated by using 1 to 9 subfields SFi in the low mode, grey levels between 10 and 20 may be generated by using 1 subfield SFi in the high mode and the other subfields SFi are either in the off mode or in the low mode, and so on. For example, the grey level 19 is generated by using the high mode in the first subfield SF1 and the low mode in the other subfields SFi or the other way around. After the first subfield SF1, an addressing pulse is applied to switch the pixel to the low mode. Now each subfield SFi adds an extra contribution of 1 to the total grey level, until the pixel is switched off entirely.

In this manner, a total of 65 grey levels is available as elucidated in the table below. This compares very favorable to the only 11 grey levels obtainable without the three-level drive.

| Available grey levels | levels used in the subfields SFi |
|---|---|
| 0-10 | 0 to 10 times low level |
| 10-19 | 1* high level + 0 to 9 times low level |
| 20-28 | 2* high level + 0 to 8 times low level |
| 30-37 | 3* high level + 0 to 7 times low level |
| . | |
| . | |
| . | |
| 80-82 | 8* high level + 0 to 2 times low level |
| 90-91 | 9* high level + 0 to 1 times low level |
| 100 | 10* high level |

The total number of grey levels depends on the number N of available subfields SFi, and the ratio R of high to low intensity levels of the high and low mode. If the ratio can be approximated by an integer, the following formula determines the number A of grey levels available (each at least one unit apart and excluding zero):

$$N < R ⟶ A = \frac{1}{2} N ( N + 3 )$$

$$N \geq R ⟶ A = \frac{1}{2} N ( N + 3 ) - \frac{1}{2} ( N - R + 1 ) ( N - R + 2 )$$

The number of grey levels increases roughly with N, until the number of subfields SFi equals the high-to-low ratio. Above this level the increase in the number of grey levels is linear with N.

Not only does the three-level sine wave drive in accordance with the invention provide a lot more grey levels than the usual two-level square wave drive, but also these grey levels are nicely distributed in time. In the lower grey level range, a lot of different levels are present. In the higher range there are less levels, although they are somewhat clustered. This distribution is quite favorable regarding perceptual effects.

FIG. 13 shows a combination of an inverse clear addressing scheme and three level driving.

In a known clear drive scheme, the pixels PCij are ignited by addressing, the exact instant depends on the grey value the pixel should have. At the end of the frame, all pixels PCij are turned off at the same instant.

This implementation has a number of advantages with respect to the clear drive scheme. The first advantage is that a pixel PCij which has to remain black (the lowest ‘grey-level’) can stay off completely. Therefore the contrast level is in theory equal to infinity. A consequence however is that the picture content can be such that a pixel is dark for quite a number of frames.

An advantage of the sine wave driving in accordance with the invention is that igniting a pixel in sine-wave driving is possible even after a much longer time period than in the known square wave driven PDP's. Experiments on the test panel showed that a pixel PCij still ignites when a pulse of 1 μs is applied, even after about 10 seconds sustaining while the pixel PCij is off.

Another advantage of the sine ware driving in accordance with the invention is that simultaneously switching-off all pixels PCij is easy. A number of options are available, the first one is to drop the sustain voltage VS below the minimum sustain voltage MSHM for a short period of time (i.e. a few sine-wave periods which equals only a few microseconds). This does not emit any extra light at all, so pixels PCij that are already in the off state, will remain in that state without emitting light. Another option is a suitable addressing pulse VD on the data electrode DEj.

In the same way as elucidated with respect to FIG. 12, the combination of the inverse-clear scheme with the three level driving provides a surprisingly high number of available grey levels.

FIG. 14 shows a circuit for generating the substantially sine wave shaped voltages VCS and VC or VS.

The circuit shown, which is part of the scan driver SD comprises a resonance inductor LR and a parallel arrangement of a series arrangement of two controllable electronic switches S1, S2 and a series arrangement of a first and a second DC power supply voltage VSUP1, VSUP2. A junction of the two controllable electronic switches S1, S2 is coupled to at least one of the first scan electrodes SEi. A junction of the first and a second DC power supply voltage VSUP1, VSUP2 is coupled to at least one of the second scan electrodes CEi. The resonance inductor LR is coupled between the junction of the two controllable electronic switches S1, S2 and the junction of the first and a second DC power supply voltage VSUP1, VSUP2. The controllable switches S1, S2 are preferably MOSFET's. The PDP is represented by the panel capacitance CP.

For the sake of simplicity, the operation of the circuit will be elucidated with respect to FIG. 15 for equal values VSUP of the first and the second supply voltage VSUP1 and VSUP2.

FIG. 15 show waveforms elucidating the operation of the circuit shown in FIG. 14. FIG. 15A shows the current IC through the panel capacitance CP. FIG. 15B shows the current IL through the resonance inductor LR. FIG. 15C shows the panel voltage VS across the panel capacitance CP.

At instant t0, the switch S1 is activated to conduct, and the first scan electrode SEi (also referred to as the scan side of the PDP) is pulled to a voltage equal to two times VSUP, while the second scan electrode or common electrode CEi (also referred to as the common side of the PDP) is held at VSUP. Consequently, the panel voltage VS equals VSUP. It is assumed that the data pulse VD on the data electrode DEj has an amplitude and timing such that the cell PCij will ignite and a light pulse will be emitted. As long as the plasma current is flowing (typically less than 1 microsecond), switch S1 remains activated. As long as switch S1 is activated, the voltage VSUP is present across the resonance inductor LR, and the current IL through the inductor LR rises linearly. After releasing the switch S1 at the instant t1, the panel capacitance CP and the resonant inductor LR form a resonant path. Because of the current IL flowing through the inductor LR at the start of the resonance cycle, the current IP will not be exactly sine wave shaped. The energy in the inductor LR at the start of the resonance cycle compensate for the losses which occur in the resonance circuit.

At the instant t2, the switch S2 is activated for about 1 microsecond. Now, the scan side of the panel is pulled to ground and the common side remains at Vsup. The plasma cells PCij to which the appropriate data voltages VD are applied will ignite and the current IL through the resonant inductor LR will decrease linearly. At the instant t3 the switch S2 is released, the panel voltage VS resonantly swings from −VSup to +VSup, and a full period of the substantially sine wave shaped voltage VS is completed at the instant t4.

A full voltage swing is reached in resonantly inverting the panel voltage VS if the starting current in the resonant inductor LR has the correct value. Consequently, the switches S1 and S2 are activated when its respective drain-source voltages are zero. The switching losses, the power dissipation, and the amount of EMI produced will be low.

FIG. 16 shows a circuit for generating the substantially sine wave shaped voltages. The scan driver SD comprises a resonance inductor LR1 which is coupled between the first and the second scan electrodes SEi, CEi. A controllable electronic switch S3 is coupled to at least one of the first scan electrodes SEi, and a DC power supply voltage VSUP3 is coupled to at least one of the second scan electrodes CEi. A diode D1 is connected in series with the DC power supply voltage VSUP3 to prevent a current to flow from the parallel arrangement of the panel capacitance CP and the resonance inductor LR1 into the DC power supply voltage VSUP3.

As an example only, in a practical implementation with the 6 inch test panel, a resonance frequency of the panel capacitance CP (of 0.4 nanofarad) and the resonance inductor LRl (250 microhenry) is selected to be approximately 500 kHz.

FIG. 17 show waveforms elucidating the operation of the circuit shown in FIG. 16. FIG. 17A shows the current IL through the resonance inductor LR. FIG. 17B shows the panel voltage VS across the panel capacitance CP.

At the instant t0, the switch S3 is closed, the scan side of the PDP panel is pulled to ground, the voltage VSUP3 is present across the resonant inductor LR1, and the current through the resonant inductor LR1 starts increasing linearly. At the instant t1, the current through the resonant inductor LR1 has reached the proper value and the switch S3 is opened. The panel capacitance CP and the resonant inductor LR1 form a resonance circuit. The resulting voltage waveform across the panel capacitance CP is a distorted sine wave of which the slopes in the first and second half are different. A small step occurs at the instant t2 due to losses in the system.

An external capacitor may be provided in parallel with the panel capacitance to obtain a more constant peak to peak value of the panel voltage VS at changing video images.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A three electrode Plasma Display Panelcomprising:
a matrix of plasma cells being associated with intersections of data electrodescrossing substantially parallel arranged first and second scan electrodes, two adjacent ones of said first and second scan electrodes being associated with the same plasma cells,
a scan driver for supplying a substantially sine wave shaped voltage between said first and second scan electrodes, an amplitude of the substantially sine wave shaped voltage being large enough to sustain plasma cells already ignited, but being not large enough to ignite the plasma cells, and
a data driver for supplying a substantially pulse shaped voltage to the data electrodes for controlling an amount of light produced by the plasma cells.

2. A three electrode Plasma Display Panel as claimed in claim 1, characterized in that the Plasma Display Panel further comprises a controller for controlling the data driver to supply the substantially pulse shaped voltage at substantially the instant the substantial sine wave shaped voltage has:
(i) an extreme value for activating a first level of light output, or
(ii) a zero crossing for activating a second level of light output.

3. A three electrode Plasma Display Panel as claimed in claim 1, characterized in that the first and second scan electrodes extend in the row direction and the data electrodes extend in the column direction, the Plasma Display Panel further comprises a controller for controlling the scan driver to superpose a scan pulse voltage on the substantial sine wave shaped voltage during the occurrence of the substantially pulse shaped voltage for not selected rows of plasma cells, an amplitude and polarity of the scan pulse voltage being selected to prevent a change of charge of the plasma cells of the not selected rows of plasma cells due to the substantially pulse shaped voltage present on the data electrodes.

4. A three electrode Plasma Display Panel as claimed in claim 1, characterized in that the first and second scan electrodes extend in the row direction and the data electrodes extend in the column direction, the Plasma Display Panel further comprises a controller for controlling the scan driver to superpose a scan pulse voltage on the substantial sine wave shaped voltage during the occurrence of the substantially pulse shaped voltage for a selected row of plasma cells, an amplitude and polarity of the scan pulse voltage being selected to allow a change of charge of the plasma cells of the selected row of plasma cells by the substantially pulse shaped voltage present on data electrodes, an amplitude of the scan pulse voltage being selected low enough to prevent a change of charge of plasma cells of not selected rows of plasma cells.

5. A three electrode Plasma Display Panel as claimed in claim 1, characterized in that the scan driver is adapted for supplying a first substantially sine wave shaped voltage to the first scan electrodes, and a second substantially sine wave shaped voltage to the second scan electrodes, the first substantially sine wave shaped voltage and a second substantially sine wave shaped voltage having a phase shift in a range of 120 to 150 degrees.

6. A three electrode Plasma Display Panel as claimed in claim 2, characterized in that the data driver has an input for receiving an input video signal to be displayed by the Plasma Display Panel, the input video signal having a field period, the controller being adapted for controlling the scan driver and/or the data driver
(i) to ignite all the plasma cells at a start of the field period,
(ii) to generate a predetermined number of subfields during the field period, and
(iii) to activate the first level of light output or the second level of light output during one of the subfields in dependence on the input video signal.

7. A three electrode Plasma Display Panel as claimed in claim 2, characterized in that the data driver has an input for receiving an input video signal to be displayed by the Plasma Display Panel, the input video signal having a field period, the controller being adapted for controlling the scan driver and/or the data driver
(i) to turn off all the plasma cells at a start of the field period,
(ii) to generate a predetermined number of subfields during the field period, and
(iii) to activate the first level of light output or the second level of light output during the subfields in dependence on the input video signal.

8. A three electrode Plasma Display Panel as claimed in claim 1, characterized in that the scan driver comprises a resonance inductor and a parallel arrangement of on the one hand a series arrangement of two controllable electronic switches and on the other hand a series arrangement of a first and a second DC power supply voltage, a junction of the two controllable electronic switches being coupled to at least one of the first scan electrodes, a junction of the first and a second DC power supply voltage being coupled to at least one of the second scan electrodes, the resonance inductor being coupled between the junction of the two controllable electronic switches and the junction of the first and a second DC power supply voltage.

9. A three electrode Plasma Display Panel as claimed in claim 1, characterized in that the scan driver comprises:
a resonance inductor being coupled between at least one of the first scan electrodes, and at least one of the second scan electrodes,
a controllable electronic switch coupled to the at least one of the first scan electrodes, and
a DC power supply voltage coupled to the at least one of the second scan electrodes.

10. A PDP apparatus comprising a Plasma Display Panel as claimed in claim 1.

11. A method of driving a three electrode Plasma Display Panel comprising a matrix of plasma cells being associated with intersections of data electrodes crossing parallel arranged first and second scan electrodes, two adjacent ones of said first and second scan electrodes being associated with the same plasma cells, the method
supplying a substantially sine wave shaped voltage between said first and second scan electrodes, an amplitude of the substantially sine wave shaped voltage being large enough to sustain plasma cells already ignited, but being not large enough to ignite the plasma cells, and
supplying a substantially pulse shaped voltage to the data electrodes for controlling an amount of light produced by the plasma cells.
